(19) United States
(12) Patent Application Publication
(10) Pub. No.: US 2004/0210492 A1
(43) Pub. Date: Oct. 21, 2004

(54) Method and system for purchasing a product

(76) Inventors: Rizwan Husain, Santa Clara, CA (US); Vernon Wyatt, San Jose, CA (US); Michael Chew, San Jose, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/418,665

(22) Filed: Apr. 17, 2003

(51) Int. Cl. G06F 17/60

(52) U.S. Cl. 705/27

(57) ABSTRACT

In an embodiment of the invention, a method for purchasing a product in an electronic commerce environment includes, conducting a product search from a catalog to obtain a product from the catalog, and purchasing the product by placing an order. In another embodiment, a system for providing the capabilities for purchasing a product in an electronic commerce environment includes, one or more storage devices for enabling a product search to be conducted from a catalog to obtain a product from the catalog and for purchasing the product by placing an order.

### FILED OF THE INVENTION

Embodiments of the invention relate generally to placing an order for a product in an electronic commerce environment, such as by telephone or through a computer network including a web site. More particularly, embodiments of the invention relate to a method and system for ordering and/or purchasing a commercial product in an electronic commerce environment.

### BACKGROUND ART

Conventional methods and systems for a customer to order and/or to purchase a commercial product does not provide for post-sales processing. Such methods and systems do not provide merchants with desired versatilities to facilitate full-fledged post-sales processing, such as account administration and checking the status of an order. If merchants had such post-sales processing opportunities for determining the status of a commercial product that was previously ordered by a customer, merchants would be in a position increase profits, such as minimizing loss sales.

### SUMMARY OF EMBODIMENTS OF THE INVENTION

Embodiments of the invention provide a method for purchasing a product in an electronic commerce environment, including, conducting a product search from a catalog to obtain a product from the catalog, and purchasing the product by placing an order. The method may additionally include, displaying the product prior to purchasing the product by placing an order, and determining the status of the order. The conducting of a product search from a catalog may include, conducting the product search in accordance with one of the following criteria: a product number, a product name, a price range of product, and a substring. The catalog search may include a full catalog search and/or browsing the catalog, including categorizing available products. The purchasing of the product may include adding the product directly from a page site to a shopping cart.

In an embodiment of the invention, the placing of an order for a product may include, logging in a customer, and checking out after logging in the customer. The process of checking out may include, obtaining credit information (e.g., a credit card) from the customer, authorizing the purchase based on the credit information from the customer, and determining if the credit information is valid for purchasing the product. If the credit information is not valid, then new credit information may be obtained from the customer. Determining the status of an order may include contacting, by the customer, a call center, logging in the customer, viewing the order, and determining whether or not to reorder the product.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a schematic block diagram that exemplarily illustrates a computer system which may be employed for various embodiments of the invention.

FIG. 2 is a functional diagram illustrating a computer network where embodiments of the invention may be employed.

FIG. 3 illustrates a schematic diagram of a system for creating and publishing web pages which may be employed for various embodiments of the invention.

FIG. 4 is a block flow diagram in accordance with an embodiment of the invention for selecting a delivery procedure for a product.

FIG. 5 is a block flow diagram for a product search which is available for various criteria.

FIG. 6 is a block flow diagram for placing an order.

FIG. 7 is a block flow diagram for status of an order.

FIG. 8 is a block flow diagram for accounts administration.

FIG. 9 is an elevational view of a screen or monitor illustrating exposed fields for username and for password for logging-in purposes.

FIG. 10 is an elevational view of a screen or monitor for ordering from a general store.

FIG. 11 is an elevational view of a screen or monitor having fields for a catalog search.

FIG. 12 is an elevational view of a screen or monitor for a catalog browse.

FIG. 13 is an elevational view of a screen or monitor illustrating an order for a digital copier.

FIG. 14 is an elevational view of a screen or monitor illustrating fields for registration of a new customer.

FIG. 15 is an elevational view of a screen or monitor illustrating fields for registration of a new agent.

FIG. 16 is an elevational view of a screen or monitor illustrating fields for entering search criteria for an agent.

FIG. 17 is an elevational view of a screen or monitor illustrating fields having information for editing a customer profile.

FIG. 18 is an elevational view of a screen or monitor illustrating fields having information for editing an agent.

FIG. 19 is an elevational view of a screen or monitor illustrating fields having payment and shipping information.

FIG. 20 is an elevational view of a screen or monitor illustrating fields having information for overviewing an order.

FIG. 21 is an elevational view of a screen or monitor illustrating fields having information for a pending authorization.

FIG. 22 is an elevational view of a screen or monitor illustrating part of the status of an order.

FIG. 23 is an elevational view of a screen or monitor illustrating the remaining part of the status of an order and including sections entitled “add comments” and “view comments”.

### DETAILED DESCRIPTION OF EMBODIMENT OF THE INVENTION

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the invention.

A “computer” for purposes of embodiments of the invention may be any processor-containing device, such as a mainframe computer, a personal computer, a laptop, a notebook, a microcomputer, a server, or any of the like. A “computer program” may be any suitable program or sequence of coded instructions which are to be inserted into a computer, well know to those skilled in the art. Stated more specifically, a computer program is an organized list of instructions that, when executed, causes the computer to behave in a predetermined manner. A computer program contains a list of ingredients (called variables) and a list of directions (called statements) that tell the computer what to do with the variables. The variables may represent numeric data, text, or graphical images.

A “computer-readable medium” for purposes of embodiments of the invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

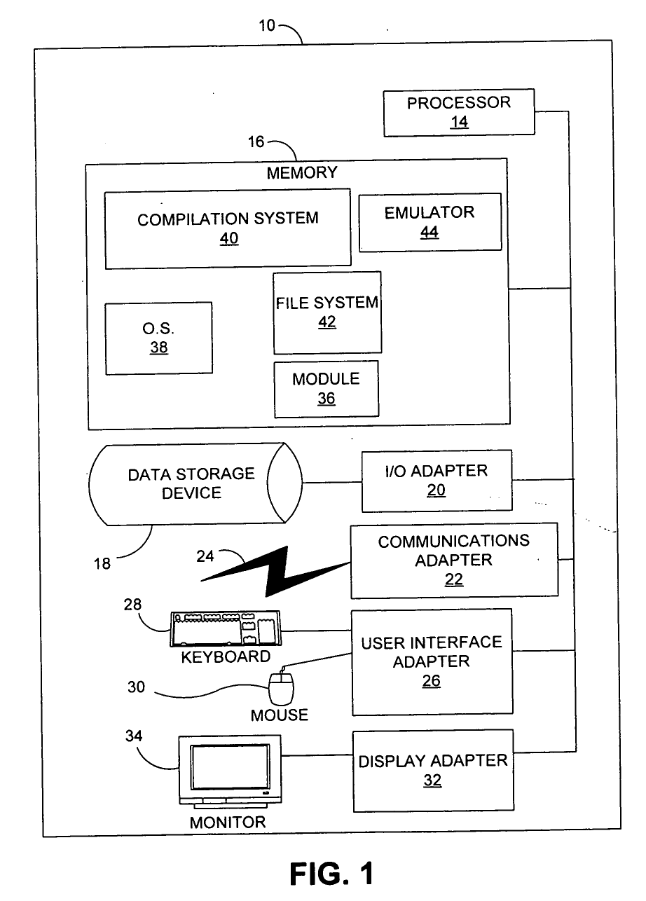

Referring now to FIG. 1 there is broadly illustrated a computer system 10 which may be employed for various embodiments of the invention. The computer system 10 includes a computer program and various components, such as a processor 14, a computer memory 16, a data storage device 18, an input/output (I/O) adapter 20, a communications adapter 22, a communications network 24, a user interface adapter 26, a keyboard 28, a mouse 30, a display adapter 32, and a computer monitor 34. It is to be understood and appreciated by those skilled in the relevant art that there are many possible configurations and arrangements of the components of the computer system 10 and that some components which may be typically included in the computer system 10 are not shown. Thus, the computer system 10 illustrated in FIG. 1 is for exemplarily purposes only and is not to unduly limit the spirit and scope of embodiments of the invention.

Computer memory 16 may be any suitable memory storage device, including random access memory (RAM), cache memory, magnetic medium such as a resident hard disk, or other memory storage devices. The term “storage” may refer to computer resources, such as the computer memory 16, and may be employed to store suitable data or instructions. For exemplarily purposes only and as best illustrated in FIG. 1, computer memory 16 may include at least one module 36, an operating system (O.S.) 38, a compilation system 40, a file system 42, and an emulator 44.

The compilation system 40 for various embodiments of the invention would comprise a compiler having a special program that processes statements written in a particular programming language and turns them into machine language or “code” that a processor, such as processor 14, uses. Traditionally, the output of a compilation system, such as compilation system 40, has been called object code or sometimes an object module. It is well known that the object code is machine code that the processor of the computer can process or “execute” one instruction at a time. Thus, stated alternatively, the compiler translates source code into object code, particularly by looking at the entire piece of source code and collecting and reorganizing the instructions.

Continuing to refer to FIG. 1 the processor 14 typically operates in cooperation with suitable software programs, including the computer memory 16, more particularly including the compilation system 40, the O.S. 38 and the module 36. Henceforth, the fact of such cooperation among the processor 14 and these components of the computer memory 16, whether implemented in software, hardware, firmware, or any combination thereof, may therefore not be repeated or further described, but will be implied for purposes of various embodiments of the invention. It is well known that a module, such as the module 36, typically operates in cooperation with the emulator 44 and the compilation system 40, but is not limited to such operation. By way of example only, the module 36 may operate in cooperation with the O.S. 38, which may in itself cooperate with the compilation system 40. The O.S. 38 may also cooperate with the file system 42 that manages the storage and access to files within the computer system 10.

The module 36 may be implemented in any suitable program language, or in any combination of software, hardware, or firmware. Thus, the module 36 may include instructions and data and be embodied in a computer-readable medium for use by or in connection with an instruction execution system, apparatus, or device, such as the computer system 10 which may pursue and derive any suitable instructions for operation. Any function ascribed to the module 36 and any of its associated functional files, whether implemented in software, hardware, firmware, or any combination thereof, may be included in the functions of the O.S. 38, since the O.S. 38 may include files from the module 36. In some instances, the functions ascribed to the module 36 may be typically performed by the processor 14 executing suitable software instructions in cooperation with aspects of the O.S. 38 that may incorporate the module 36. Therefore, it is to be understood that the module 36 may cooperate with aspects of the O.S. 38.

It will be appreciated by those skilled in the relevant art that the term “execute” may mean the process of manipulating code, such as software, for operation on the computer system 10. It will be further appreciated by those skilled in the relevant art that the term “code” may refer to any suitable instructions or data used by the computer system 10 for the purpose of generating instructions that can execute in the computer system 10. As indicated, the term “module” may refer to a software “procedure” or “function” such as a unit of code that may be independently compiled.

The emulator 44, as well as the compilation system 40 and the O.S. 38, may reside in the computer system 10, more particularly in the computer memory 16 of the computer system 10. The emulator 44 may substitute instructions typically associated with a different computer system than the executing computer system 10, for any original instruction. Any substitute instruction may be associated with a hardware, software, or firmware representation of a different computer system 10.

The data storage device 18 may be any suitable storage device, including a compact disk drive, a tape drive, a removable hard disk drive, or diskette drive. The data storage device 18 may communicate with the I/O adapter 20, which in turn communicates with other components of the computer system 10, in order to retrieve and store data used by the computer system 10. The data storage device 18 typically includes a computer storage medium having stored therein a computer software program and data.

The computer system 10 for embodiments of the invention includes suitable input/output devices for accepting input information and promulgating generated information. Input/output devices may include any suitable storage device, such as a compact disk drive, a tape drive, a removable hard disk drive, or a diskette drive. Suitable input devices include, by way of example only, the keyboard 28, the mouse 30, a touch-screen display (not shown), a touch pad (not shown), a microphone including a voice recognition device (not shown), a network card (not shown), or a modem (not shown). The input devices may communicate with the user interface adapter 26 which in turn communicates with components in the computer system 10 for processing input and output commands. Program code may typically be loaded through a suitable input device and may be stored on the data storage device 18. A copy of the program code, or any portion thereof, may alternatively be disposed by the processor 14 in the computer memory 16 for subsequent execution on the computer system 10.

Output devices may include any suitable output devices for presenting generated information to a user, whether a human or a machine, and whether local or remote. Such devices may include, by way of example only, the computer monitor 34, a printer (not shown), an audio speaker with a voice synthesis device (not shown), a network card (not shown), or a modem (not shown). Output devices, such as the monitor 34, may communicate with other components in the computer system 10 through the display adapter 32.

The computer system 10 for various embodiments of the invention may communicate with communications network 24 via the communications adapter 22, such as a networking card. It is to be appreciated that any suitable input/output device employed by the module 36 may be coupled to the communications network 24 through the communications adapter 22 and therefore may not necessarily be co-located with the computer system 10. Similarly other portions of the computer system 10, such as the data storage device 18 and the monitor 34, may be coupled to the communications network 24 through the communications adapter 22 and may also not be necessarily co-located with the computer system 10.

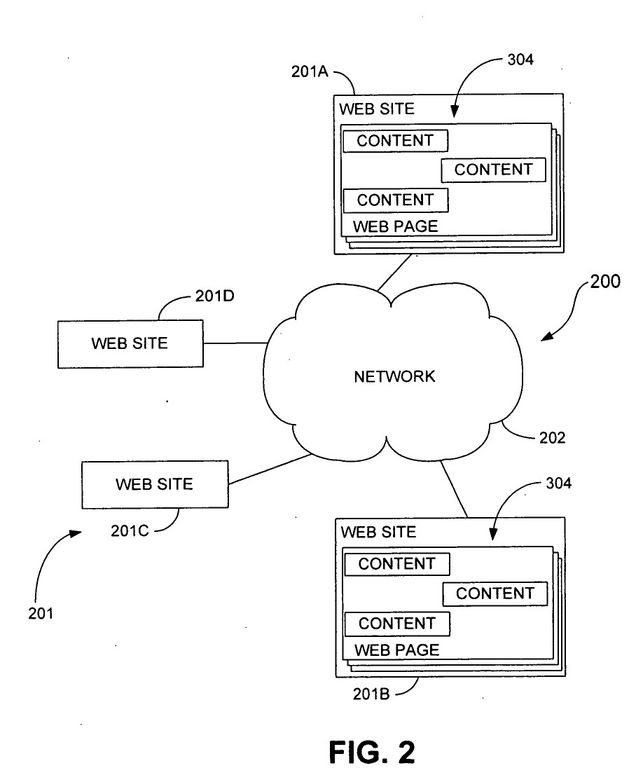

It is to be appreciated that the communications network 24 may be a local area network, a wide area network, or any other suitable computer network, such as network 202 in FIG. 2. Network 202 may be an intranet or the Internet which enables fast and relatively widespread dissemination of information. On the Internet, for example, web sites containing one or more web pages may be accessed by users having a computer system (e.g., computer system 10), a web browser, and a device (e.g., communications adapter 22) for coupling the computer system to the Internet. A web page may contain information on various topics, such as topics (e.g., catalog search/browse, placing an order, determining the status of an order, accounts administration, etc) pertaining to electronic-commerce embodiments of the invention.

Embodiments of the invention will be described in the context of web page publishing on the Internet. It should be understood, however, that embodiments of the invention are not to be limited to web page publishing on the Internet and may be used in any suitable electronic-commerce environment, including intranet, telefaxing, telephone, and so forth.

Referring again now to FIG. 2, there is seen a web site assembly, generally illustrated as 200, where embodiments of the invention may be employed. In FIG. 2 one or more web sites 201 (e.g., web sites 201A, 201B, 201C and 201D) which couple to and communicate with the network 202. As indicated the network 202 may include the Internet, an intranet or any other type of computer networks.

The web site 201 may be hosted in a computer system, such as computer system 10, or any data processing device which is capable of communication over a network, such as network 202. By way of example only, the web site may be hosted in a web server computer such as those available from the Hewlett-Packard Company. As illustrated in FIG. 2, the web site 201 may include one or more web pages, with each page including various contents, such as images, text, computer programs, downloadable files, audio, video, etc. The web pages may be structured such that they are on various levels. For example, a home page may be presented as a first level web page, with a hyperlink on the home page allowing access to a second level web page, and so on.

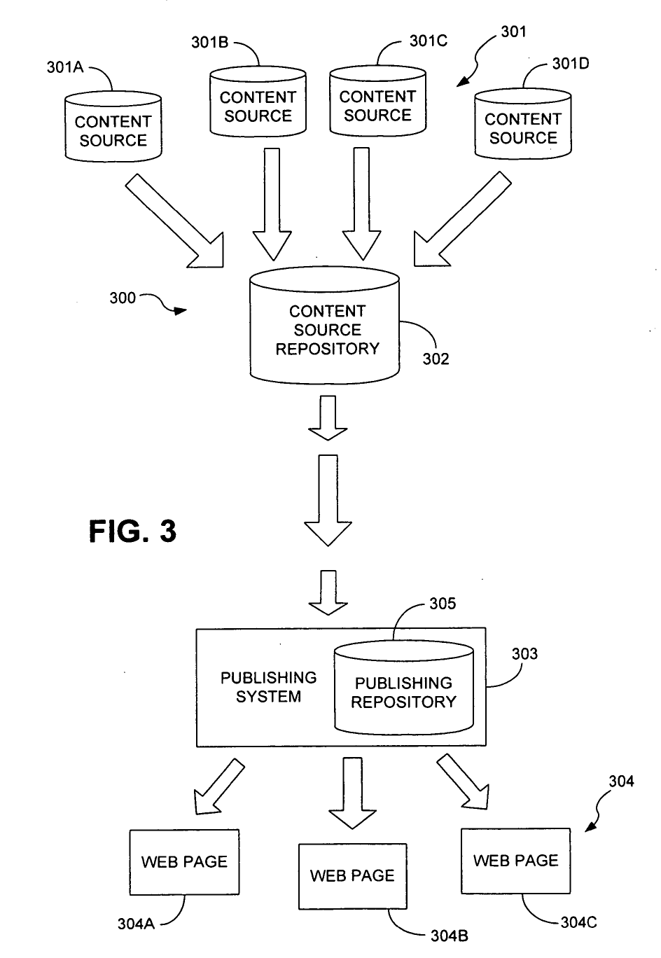

Referring now to FIG. 3, there is illustrated a schematic diagram for a system, generally illustrated as 300, that be used for creating and publishing web pages which may be employed for various embodiments of the invention. The components of system 300, as well as all other components referred to herein, may be implemented in hardware, software, or a combination of hardware and software, such as firmware. As seen in FIG. 3, a content-source repository 302 receives contents from content sources (e.g., content sources 301A, 310B, 301C and 301D). A content source 301 may a local or remote file system, a remote repository, or web site personnel entering content from a suitable terminal, etc. By way of example only, the content source 301 may be a database in a remote data center in communication with a suitable computer system, such as computer system 10, having the content-source repository 302 (e.g., the data storage device 18 functioning as a repository). The content sources may come from various sources, such advertising and sales from a marketing department. For various embodiments of the invention content sources may include information for exposing fields for placing an order, information for exposing fields for determining the status of an order, etc.

The content source repository 302 includes a database that serves as a central repository of contents from the various sources. The database may be any suitable data base such as the type available from the Oracle Corporation. Contents may be stored and retrieved from content source repository 302 as data or objects. Contents uploaded to content source repository 302 from a file system may be stored as binary data or referenced with pointers to the file system.

As appreciated by those artisans skilled in the art, content source repository 302 facilitates collection and retrieval of contents. Contents that may be shared among web pages may be stored in the content source repository 302. By storing appropriate contents in the content source instead of simply entering them directly into a web page, contents from different sources may be created once and used multiple times in different web pages. Content source repository 302 also facilitates control of content type and format so that the resulting web pages conform to a common standard, maintain a consistent look and feel, and uniformly display brands or trademarks and the like.

Appropriate content may be removed or pulled from content source repository 302 as needed by a computer-hosting publishing system 303 which publishes a web page 304 (e.g., web pages 304A, 304B, 304C) in a suitable computer network, such as an intranet or Internet. Publishing system 303 includes a publishing repository 305 (e.g., a database) for storing contents of web pages to be published. As indicated, such contents may be copied from content source repository 302 into a publishing repository 305. This allows web pages 304 to receive content from publishing repository 305.

Storing the content of web pages 304 in publishing repository 305 removes a storage burden from the content source repository 302 and facilitates publication of web pages 304. Additionally, it allows available contents in the provisioning repository 302 to be separated from contents (i.e., those in publication repository 305) which are to be published for better control of the publication process by the publishing system 303 and web pages 304.

A web page 304 may be published by storing it in a web server computer. A web page 304 may also be published by dynamically creating and delivering it to a node in a computer network upon request. Once a web page 304 is published, computers coupled to the same network as the web server computer may then access the web page 304. For example, the web page 304 may be published by making it available from a web site accessible via the intranet or the Internet.

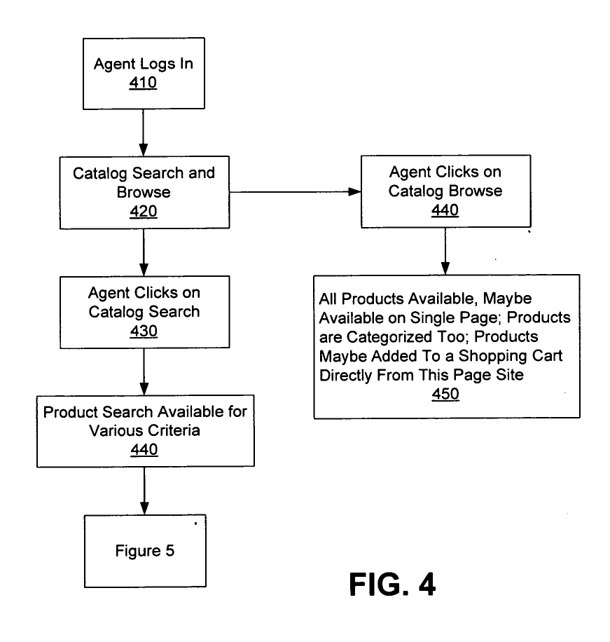

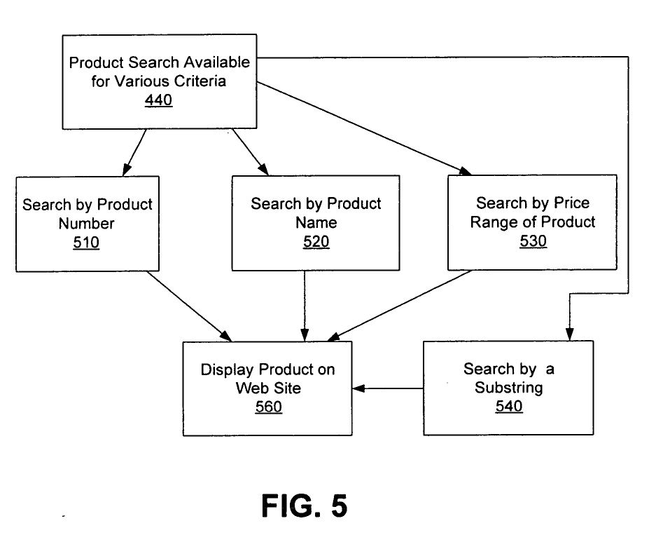

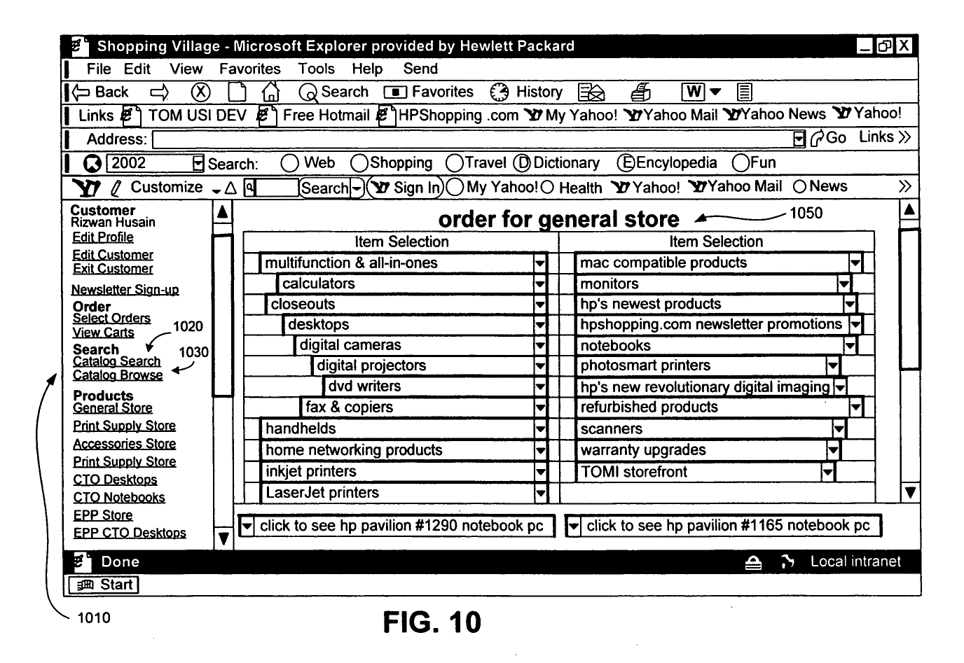

Referring now to FIGS. 4-5 and 9-13, there is seen in FIGS. 4 and 5 a block flow diagram for a catalog search and a catalog browse. The agent logs in accordance with the instructions of block 410 of FIG. 4 by entering a username and a password in field 910 and field 920, respectively, as illustrated in FIG. 9 to expose a left navigation bar, identified in FIG. 10 as 1010. The left navigation bar 1010 includes in accordance with block 420, catalog search 1020 and catalog browse 1030. FIG. 10 also illustrates an order for a general store, generally illustrated as 1050. The agent may click on catalog search 1020 as represented by block 430 or on catalog browse 1030 as represented by block 440.

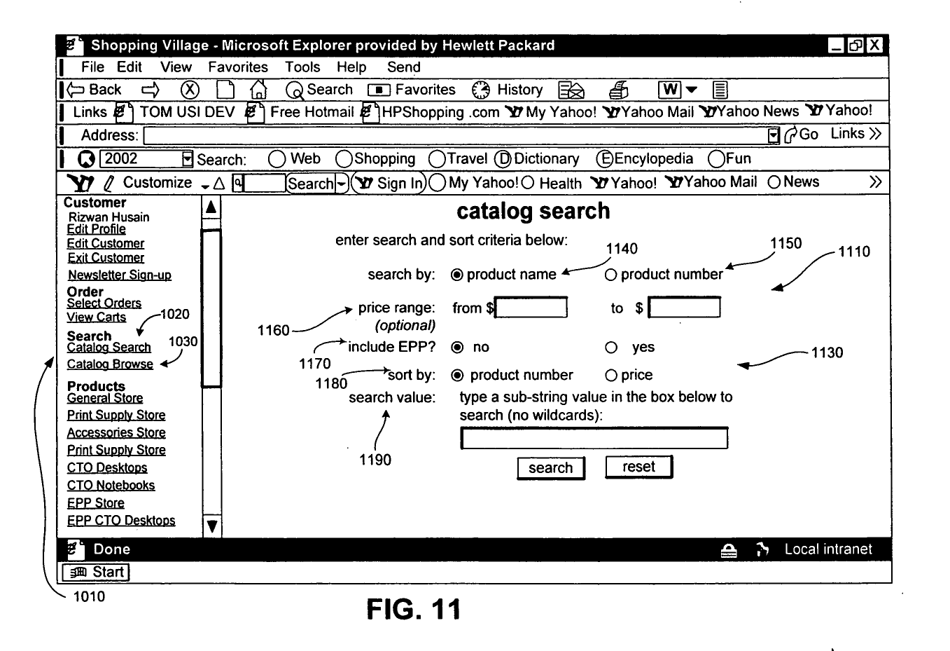

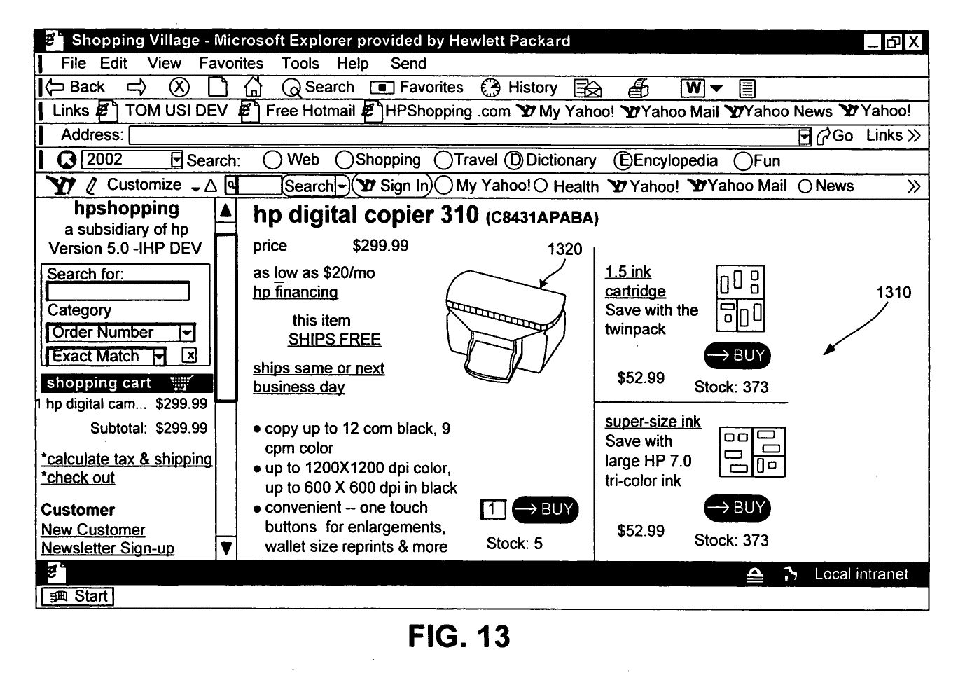

By clicking on catalog search 430, a screen or monitor, generally illustrated as 1110 in FIG. 11, is presented for exposing a plurality of fields, generally illustrated 1130, for searching a product in accordance with block 440, by product name 1140 (see instructions in block 510 in FIG. 5) or product number 1150 (see instructions in block 520 in FIG. 5) by entering search and sort criteria. Fields 1130 includes search by price range 1160 (see instructions in block 530 in FIG. 5), whether or not to include EPP 1170 (employee purchase program), whether or not to sort 1180 by product number, and search by value 1190 (i.e., entering a sub-string value in accordance with instructions in box 540 in FIG. 5). After a search in accordance with the instructions of one of the blocks (i.e., one of blocks 510, 520, 530 or 540) has been completed, the product is displayed on a web site (e.g., the web site of FIGS. 2-3) in accordance with the instructions in block 560 of FIG. 5. FIG. 13 is an elevational view of a screen or monitor 1310 displaying a product 1320 (i.e., a digital copier).

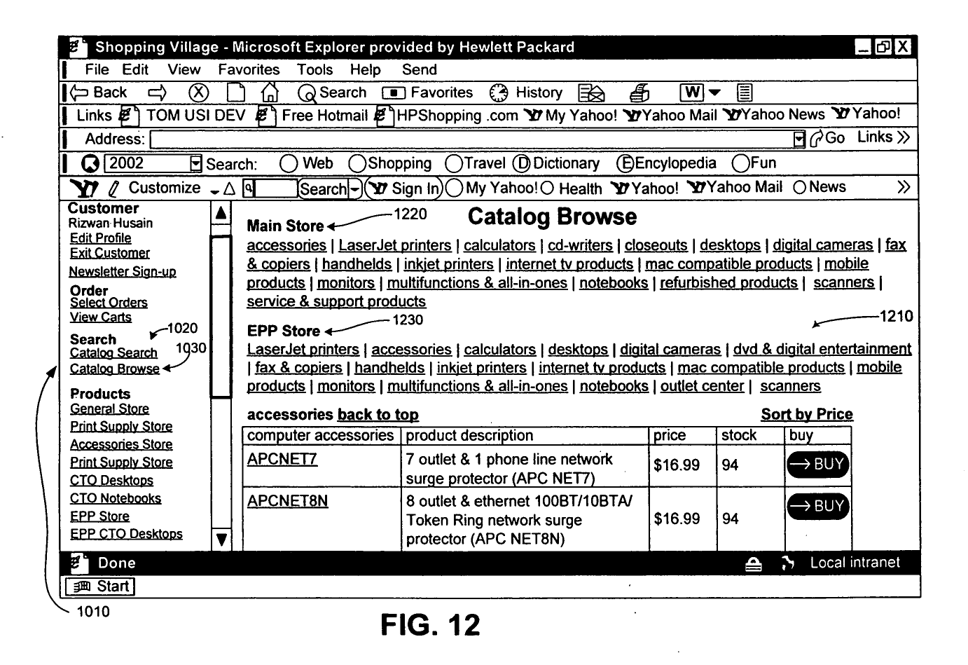

By clicking on catalog browse 440, a screen or monitor, generally illustrated as 1210 in FIG. 12, is presented for listing all available products under a main store 1220 and under an EPP store 1230. Products under the main store 1220 may include any suitable products, including accessories, laser-jet printers, calculators, compact-disk writers, closeouts, desktops, digital cameras, etc. Products under the EPP store 1230 also may include any suitable products. The products may be listed on a single page, as well as being categorized, such as alphabetically, e.g., under headings “computer accessories”, “product description”, “price”, and “stock”, etc. Any products purchased from the page broadly illustrated by the screen or monitor 1210 in FIG. 12 may be added to a shopping cart directly from this page site, in accordance with the instructions of block 450 in FIG. 4.

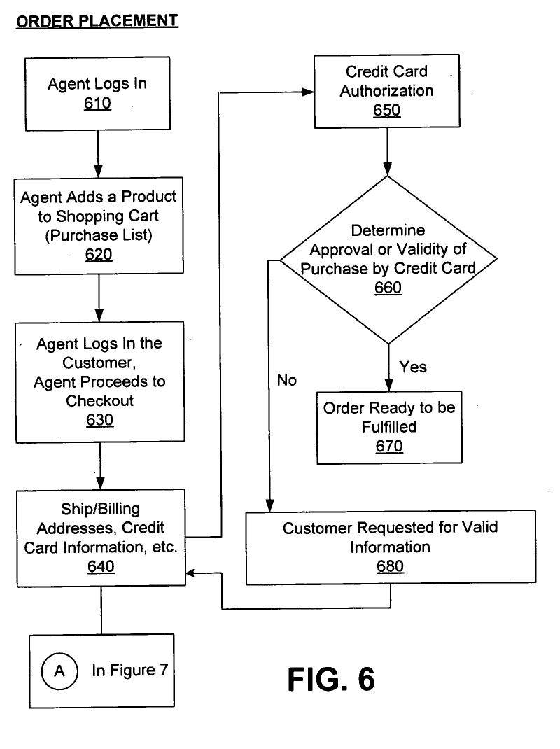

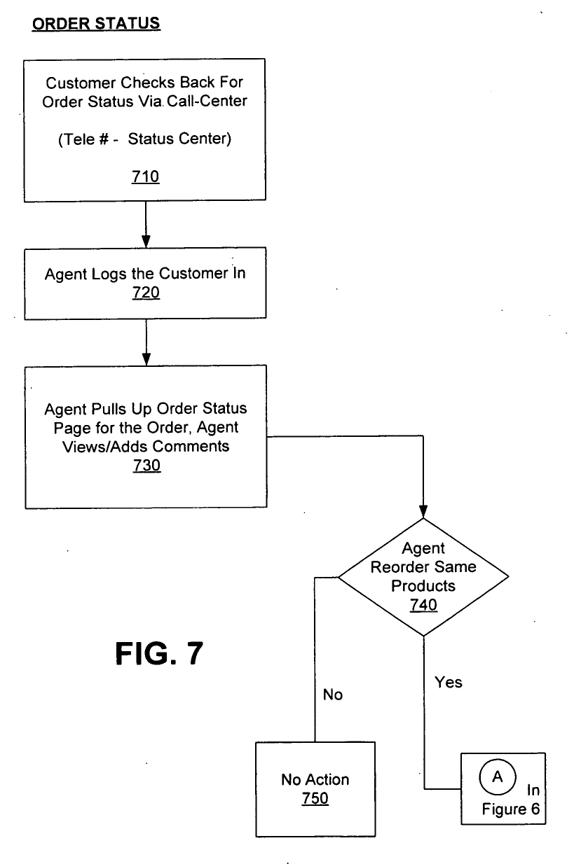

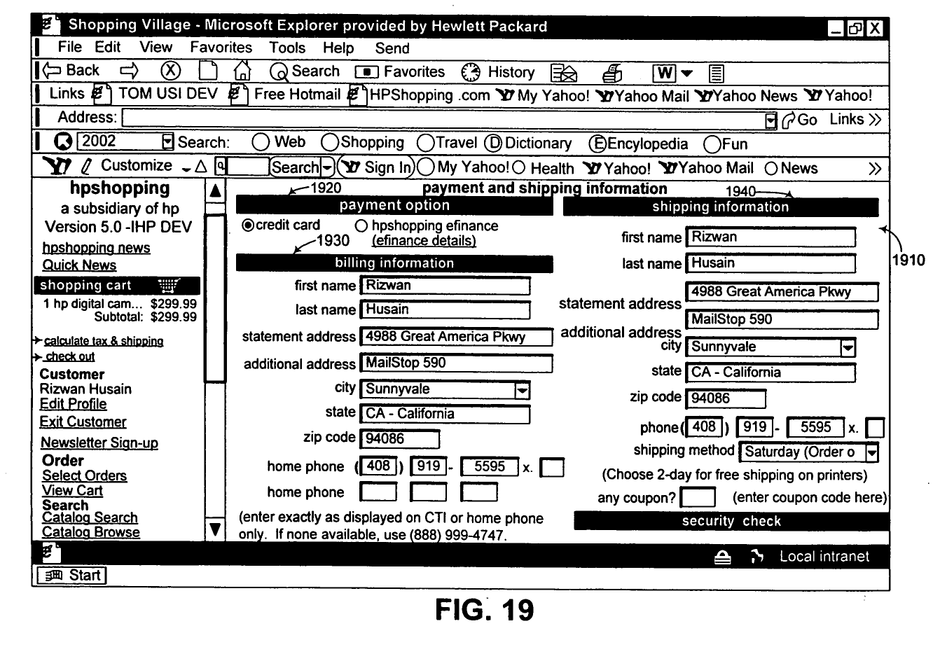

Referring now to FIG. 6 for an order placement by an agent, the agent logs-in in accordance with the instructions in block 610. Subsequently as illustrated by block 620, the agent may add to a shopping cart (a purchase list) a product requested by a customer. After all products have been added to a customer's shopping cart per block 620, the agent logs-in the customer and then proceeds to checkout, as represented by the instructions in block 630. Checkout comprises a serious of screen clicks and includes obtaining appropriate shipping and billing addresses, credit card information, and/or other information (see instructions in block 640). FIG. 19 illustrates a screen or monitor displaying payment and shipping information, generally illustrated as 1910, which includes payment option 1920, billing information 1930, and shipping information 1940.

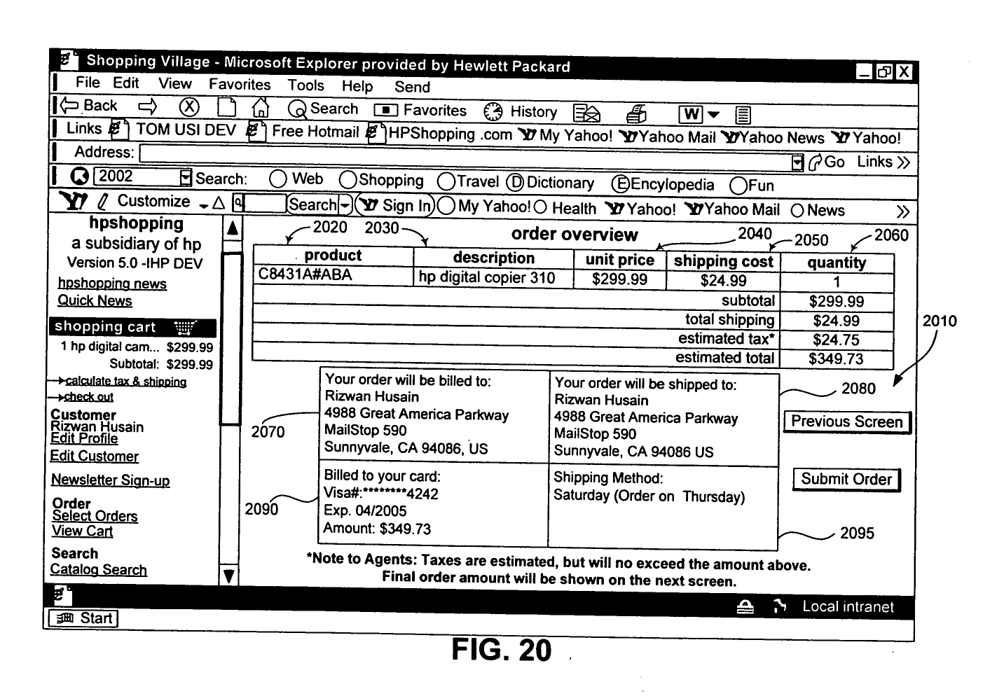

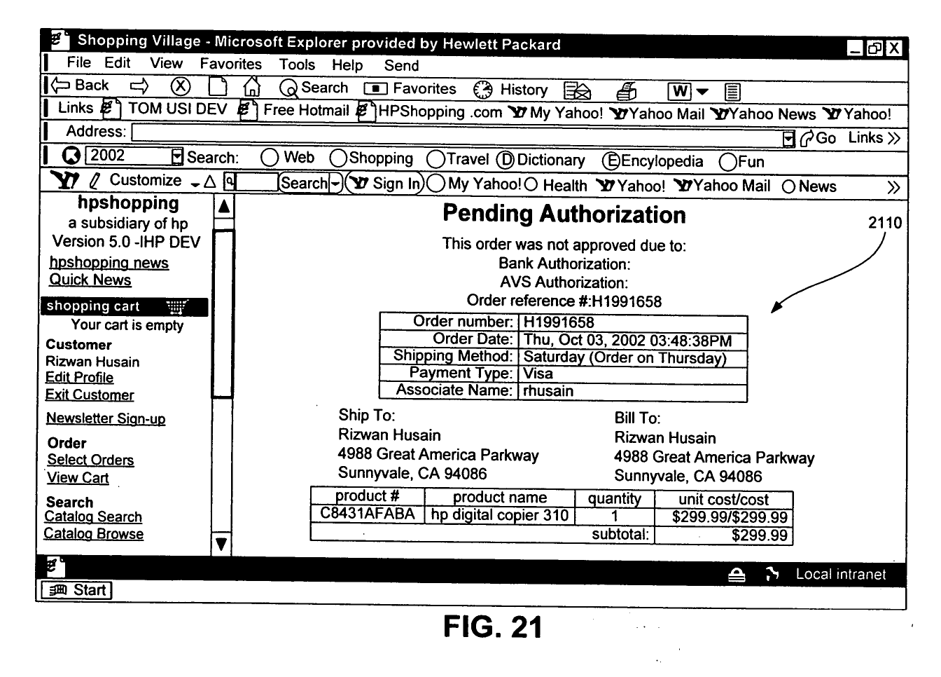

After checkout the agent may then obtain credit card authorization from the customer. FIG. 20 is an elevational view of a screen or monitor illustrating an order overview, generally illustrated as 2010. Overview 2010 includes the following headings: product 2020, description 2030, unit price 2040, shipping cost 2050, and quantity 2060. The overview 2010 in FIG. 20 also comprises order information 2070, shipping information 2080, credit card billing information 2090, and shipping method 2095. After obtaining credit card information/authorization from the customer, the agent may subsequently in accordance with decision block 660 and as reflected under “Pending Authorization” on the screen monitor 2110 in FIG. 21, determine the approval or the validity of the purchase(s) by the credit card. If the purchase(s) is/are approved, the order is ready to be fulfilled (see instructions in block 670). If the purchase(s) by credit card is/are declined or not approved, the agent requests correct and/or valid information (e.g., another credit card number, etc.) from the customer, and the procedure of blocks 640, 650 and 660 are repeated until a positive or “yes” response has been obtained from decision block 660 to fill the order in accordance with block 670. The screen monitor 2110 in FIG. 21 states: “this Order was not approved due to: . . . Bank Authorization: . . . AVS Authorization: . . . Order reference #: H1991658”

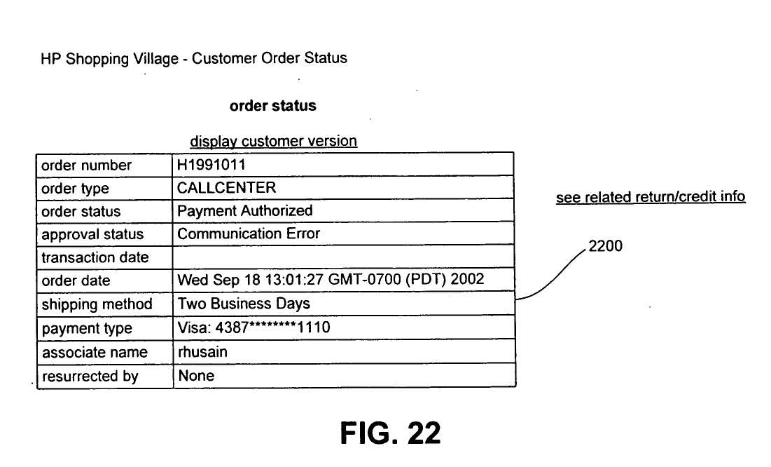

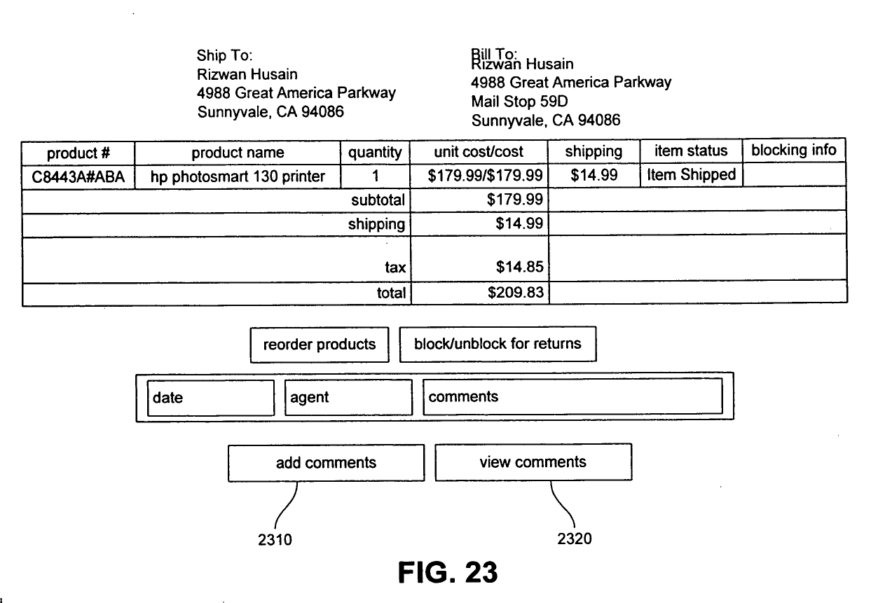

A customer may check the status of an order in accordance with the logic of block flow diagram of FIG. 7. More specifically, a customer may check the status of an order, as stated in block 710) through a call center (e.g., calling a telephone number-status center) where an agent may be located. Subsequently, as illustrated by block 720, the agent logs-in the customer, and pulls up an order status page, generally illustrated as 2200 in FIG. 22. FIG. 23 also includes part of the order status page which includes an add comments section 2310 and a view comments section 2320 for the agent to add comments or to view comments, respectively, by clicking on the appropriate desired section. After the agent determines the status of an order, a determination is made in accordance with decision block 740 whether or not to reorder the product(s) previously ordered. If the determination by decision block 740 is “no”, then no action needs to be taken by the agent, as reflected by the instructions in block 750. If the determination by decision block is affirmative or “yes”, then the product(s) is/are reordered and the agent performs or repeats the procedures of blocks 640, 650, 660, 670, and 680 in FIG. 6.

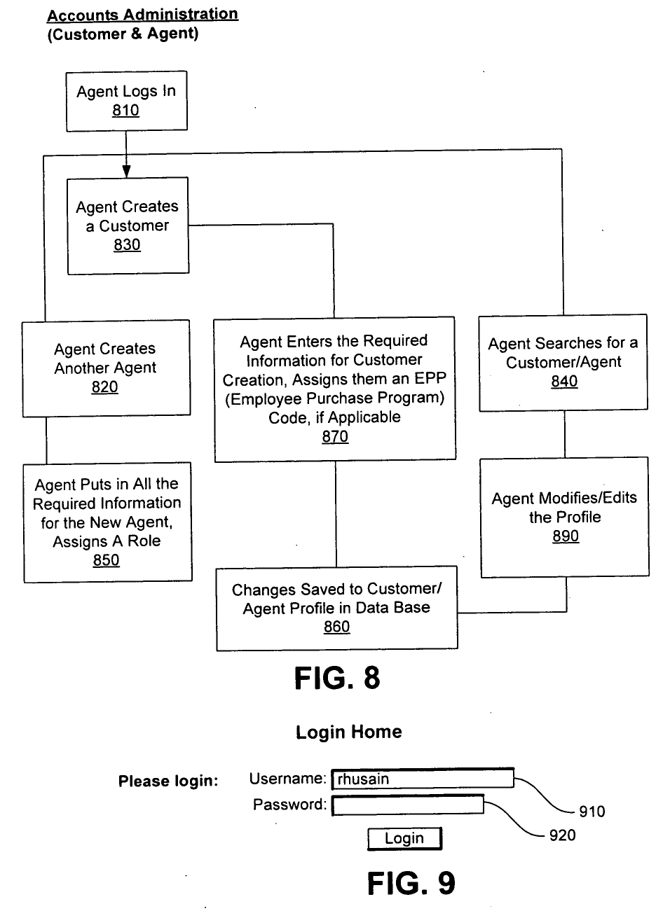

Referring now to FIGS. 8 and 14-18 for the procedure of creating a customer, an agent, or for modifying/editing the profile of an agent/customer (e.g., an accounts administration), there is seen in FIG. 8 a block flow diagram. Initially, the agent logs-in as illustrated by block 810. The agent may then: (i) create another agent, as reflected by the instructions in blocks 820 and 850; (ii) create a customer, as reflected by the instructions in blocks 830 and 870; and/or (iii) edit or modify the profile of an existing agent and/or customer after searching for same, as reflected by the instructions in blocks 840 and 890. After another agent or a new customer has been created, or after the profile of an agent or customer has been edited or modified, the data reflected in creating another agent or customer, or the changes to an agent's or customer's profile may saved in an appropriate data base, such as the data base of the computer system 10 of FIG. 1 (see instructions in block 860).

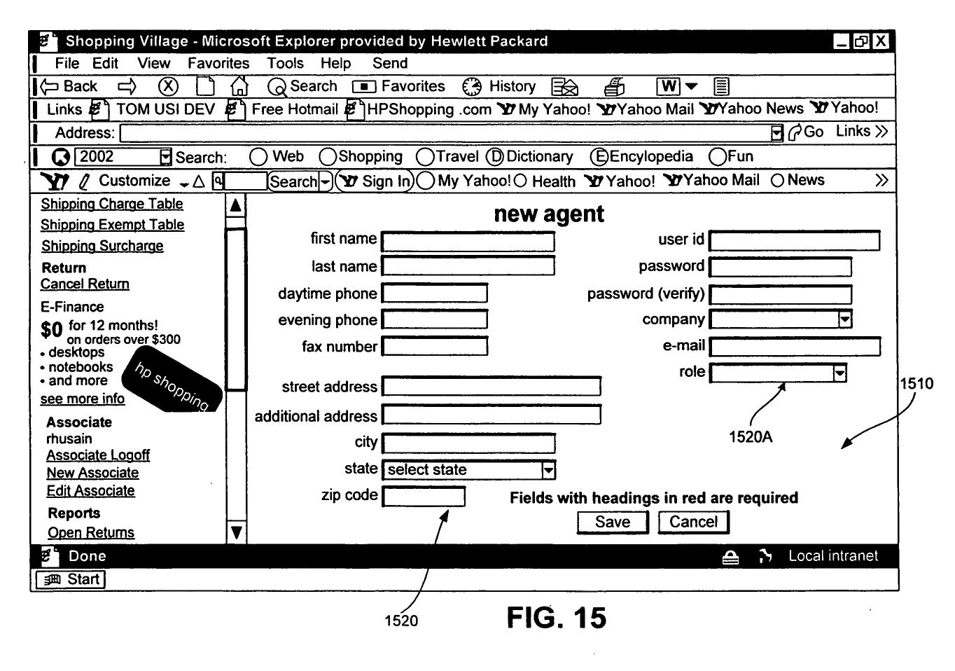

FIG. 15 is an elevational view of screen or monitor 1510 having exposed fields 1520 for entering information for a new agent (see instructions in block 850). After the appropriate information has been entered in the exposed fields 1520, a role is assigned in field 1520a.

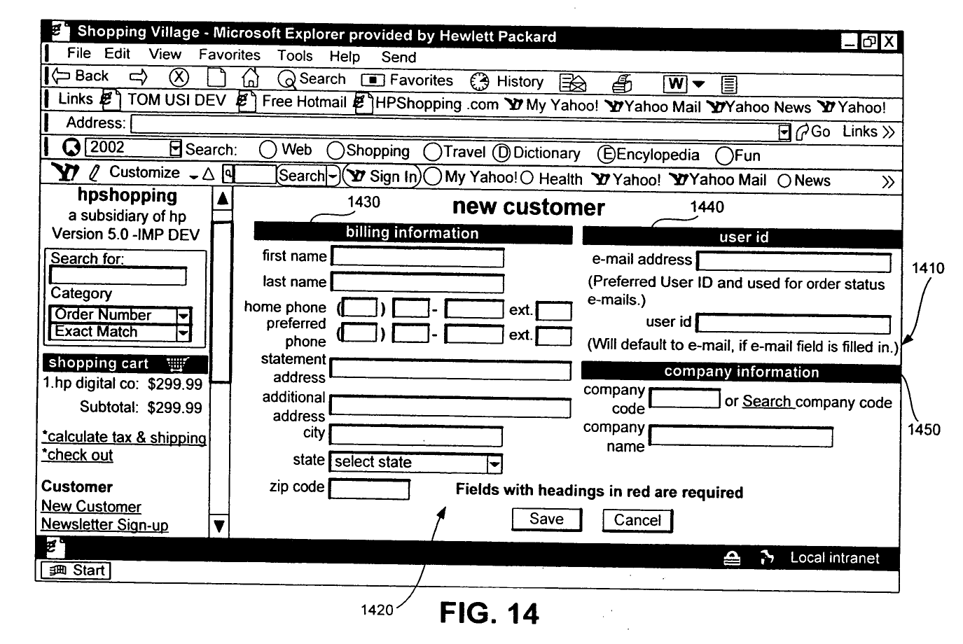

FIG. 14 is an elevational view of screen or monitor 1410 having exposed fields 1420 for entering information for a new customer (see instructions in block 870). The appropriate information for the exposed fields 1420 is to be listed under the headings: billing information 1430, user id 1440, and company information 1450.

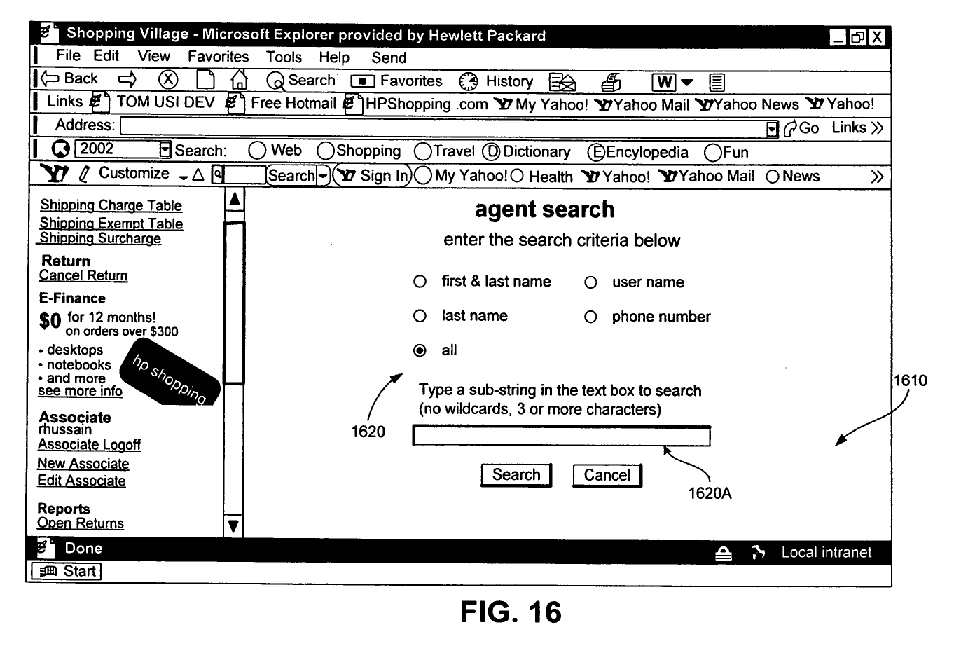

FIG. 16 is an elevational view of screen or monitor 1610 having exposed fields 1620 for entering information to search (see instructions in block 840) for an agent or customer to edit or modify the profile of the agent or customer (see instructions in block 870). Exposed fields 1620 comprises field 1620a for entering appropriate information as part of the search criteria (e.g., first and last name, user name, etc).

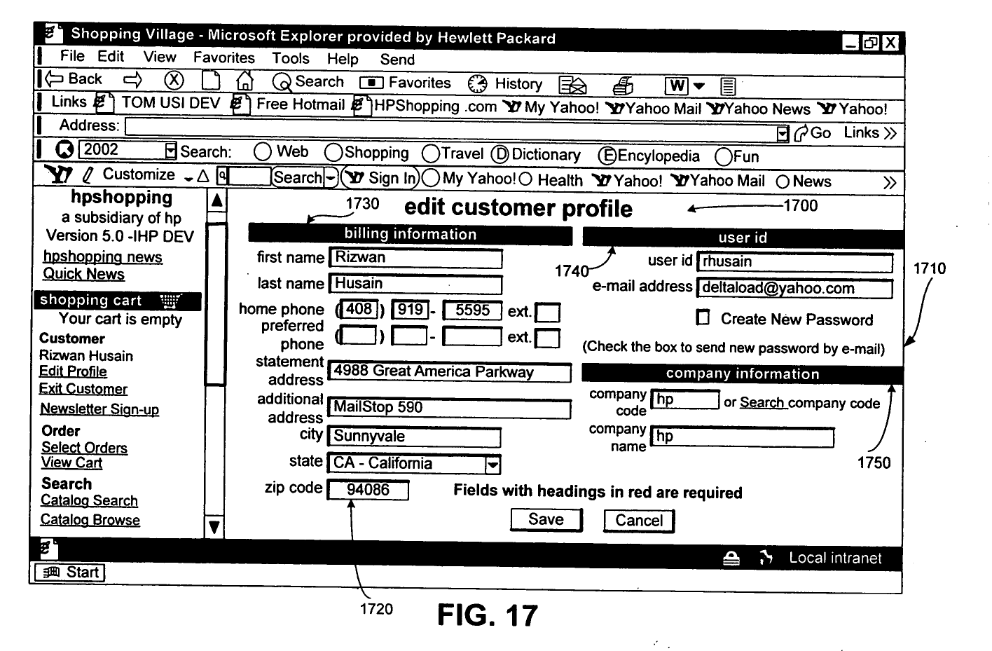

If a customer is to be searched per instructions in block 840, after the customer has been found in the computer system (e.g., the computer system 10 of FIG. 1), the customer's profile, generally illustrated as 1700 in FIG. 17, is displayed for edit or modification. As indicated, FIG. 17 is an elevational view of a screen or monitor 1710 having exposed fields 1720 for entering information to edit a customer's profile (see instructions in block 890). The appropriate information for the exposed fields 1720 is to be listed under the headings: billing information 1730, user id 1740, and company information 1750.

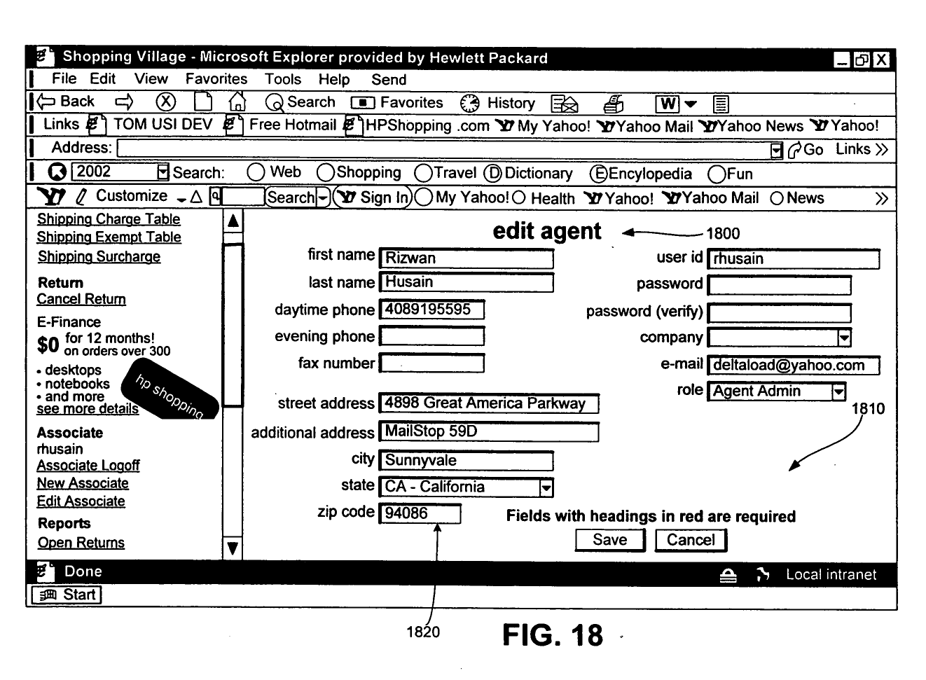

If an agent is to be searched per instructions in block 840, after the agent has been found in the computer system (e.g., the computer system 10 of FIG. 1), the agent's profile, generally illustrated as 1800 in FIG. 18, is displayed for edit or modification. As indicated, FIG. 18 is an elevational view of a screen or monitor 1810 having exposed fields 1720 for entering information to edit an agent's profile (see instructions in block 890).

A computer-implemented method may be provided for handling a merchandise or product return request from a customer of a merchant. More specifically, the method may comprise receiving customer identification data which is capable of uniquely identifying the customer among customers of the merchant, receiving a return transaction definition including at least one of a problem type parameter and a return transaction type parameter, and automatically ascertaining from a database of items previously ordered, a set of return-eligible items, each representing an item of merchandise previously ordered by the customer that conforms to the return transaction definition and predefined return-related business rules of the merchant. A return management system for handling merchandise/product return requests from customer of a merchant may be computer-implemented and comprise a plurality of tables implemented in a relational database. A user-interface module may be included and configured to interact with one of a customer of the merchant and a customer service agent of the merchant, and further configured to receive customer identification data and a return transaction definition associated with a request for merchandise/product return from a customer associated with said customer identification data. A business logic module communicably coupled with the user interface module and the plurality of tables, and including computer instructions for ascertaining whether an item of merchandise/product previously purchased by the customer is eligible for return based on the return transaction definition and predefined return-related business rules of the merchant.

Reference throughout this specification to “one embodiment”, “an embodiment”, or “a specific embodiment” means that a particular feature, structure, or characteristic described in connection with the embodiment is included in at least one embodiment of the invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the invention may be combined in any suitable manner with one or more other embodiments. It is to be understood that other variations and modifications of the embodiments of the invention described and illustrated herein are possible in light of the teachings herein and are to be considered as part of the spirit and scope of the invention.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It is also within the scope of embodiments of the invention to implement a program or code that can be stored in a machine-readable medium to permit a computer to perform any of the methods described above.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for purchasing a product in an electronic commerce environment, the method comprising:
conducting a product search from a catalog to obtain a product from the catalog; and
purchasing the product by placing an order.

2. The method of claim 1 additionally comprising displaying the product prior to purchasing the product by placing an order.

3. The method of claim 1 additionally comprising determining the status of the order.

4. The method of claim 1 wherein said conducting a product search from a catalog comprises conducting the product search in accordance with one of the criteria including product number, product name, price range of product, and substring.

5. The method of claim 2 wherein said conducting a product search from a catalog comprises conducting the product search in accordance with one of the criteria including product number, product name, price range of product, and substring.

6. The method of claim 3 wherein said conducting a product search from a catalog comprises conducting the product search in accordance with one of the criteria including product number, product name, price range of product, and substring.

7. The method of claim 1 wherein said catalog search comprises browsing the catalog.

8. The method of claim 7 wherein said browsing the catalog includes categorizing available products.

9. The method of claim 8 wherein said purchasing of the product comprises adding the product directly from a page site to a shopping cart.

10. The method of claim 1 wherein said placing an order comprises logging in a customer, and checking out after logging in the customer.

11. The method of claim 10 wherein said checking out comprises obtaining credit information from the customer, authorizing the purchase based on the credit information from the customer, and determining if the credit information is valid for purchasing the product.

12. The method of claim 11 wherein said credit information comprises a credit card.

13. The method of claim 11 additionally comprising requesting new credit information from the customer after determining that the credit information is invalid.

14. The method of claim 3 wherein said determining the status of an order comprises:
contacting by the customer a call center;
logging in the customer;
viewing the order; and
determining whether or not to reorder the product.

15. The method of claim 14 additionally comprising adding comments to the order.

16. The method of claim 14 additionally comprising reordering the product, and said checking out comprises obtaining credit information from the customer, authorizing the purchase based on the credit information from the customer, and determining if the credit information is valid for purchasing the product.

17. The method of claim 16 wherein said credit information comprises a credit card.

18. The method of claim 17 additionally comprising requesting new credit information from the customer after determining that the credit information is invalid.

19. The method of claim 1 additionally comprising creating information with respect to the customer or an agent.

20. The method of claim 18 additionally comprising creating information with respect to the customer or an agent.

21. The method of claim 1 additionally comprising searching for information pertaining to a customer or an agent, and modifying a profile of a customer or an agent after searching.

22. An article of manufacture, comprising:
a machine-readable medium having stored thereon instructions to:
conduct a product search from a catalog to obtain a product from the catalog; and
purchasing the product by placing an order.

23. A system for providing the capabilities for purchasing a product in an electronic commerce environment, the system comprising:
one or more storage devices for enabling a product search to be conducted from a catalog to obtain a product from the catalog and for purchasing the product by placing an order.

24. A system for providing the capabilities for purchasing a product in an electronic commerce environment, the system comprising:
means for storing data for enabling a product search to be conducted from a catalog to obtain a product from the catalog and for purchasing the product by placing an order.

25. The system of claim 24, wherein the means for storing and for purchasing can provide the step of returning the purchased product.

26. The system of claim 25 wherein said step of returning the purchased product comprises receiving customer identification data which is capable of uniquely identifying the customer among customers of a merchant; receiving a return transaction definition including at least one of a problem type parameter and a return transaction type parameter; and automatically ascertaining, from a database of items previously ordered, a set of return-eligible items, each representing an item of merchandise previously ordered by the customer that conforms to the return transaction definition and predefined return-related business rules of the merchant.
